(19) United States
(12) Patent Application Publication
(10) Pub. No.: US 2013/0000463 A1
(43) Pub. Date: Jan. 3, 2013

(54) INTEGRATED MUSIC FILES

(76) Inventor: Daniel Grover, White River Junction, VT (US)

(21) Appl. No.: 13/537,366

(22) Filed: Jun. 29, 2012

Related U.S. Application Data
(60) Provisional application No. 61/504,046, filed on Jul. 1, 2011.

(51) Int. Cl. G09B 15/02

(52) U.S. Cl. 84/483.2

(57) ABSTRACT

Methods, systems, and apparatus, including computer programs encoded on one or more computer storage devices pertaining to integrated music files, The methods include receiving data representative of notes associated with a musical piece. The methods include generating an image that includes at least one glyph, the glyph including a graphical representation of one of the notes of the musical piece. The methods include generating a musical file, the music file including instructions for causing the computer to play the notes of the musical piece. The methods include generating a mapping that referencing the instructions and the glyph. The methods also include generating a sheet music data file, the sheet music data file including the image, the music file, and the mapping.

### CROSS-REFERENCE TO RELATED APPLICATIONS

This application claims priority to U.S. Provisional Application Ser. No. 61/504,046, filed on Jul. 1, 2011, entitled “INTEGRATED MUSIC FILES,” the entire contents of which are hereby incorporated by reference.

### TECHNICAL FIELD

This document generally describes digital music.

### BACKGROUND

Music files can be provided digitally over a network, such as the Internet. Copyrighted works can be licensed or sold in on-line marketplaces.

The traditional craft of sheet music engraving is one that has not lent itself well to computerization. Because western music notation evolved over so many centuries, it is filled with a myriad of symbols and alternative notations for expressing different ideas. In addition, a great deal of the craft's body of knowledge exists only as oral tradition, passed from master to apprentice, with very few works formally codifying its best practices.

### SUMMARY

This document describes techniques for creating and utilizing integrated music files.

In general, one innovative aspect of the subject matter described in this specification can be embodied in methods that include the actions of receiving data representative of notes associated with a musical piece. The actions also include generating an image that includes at least one glyph, the glyph including a graphical representation of one of the notes of the musical piece. The actions also include generating a musical file, the music file including instructions for causing the computer to play the notes of the musical piece. The actions also include generating a mapping that referencing the instructions and the glyph. The actions also include generating a sheet music data file, the sheet music data file including the image, the music file, and the mapping.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The methods may include the actions of receiving second data representative of text associated with the music piece, identifying dynamic markings in the text, and updating the notation with the dynamic markings. Generating the mapping may include identifying a location of a glyph of the at least one glyph relative to the image, the glyph corresponding to a note and storing the in the music file instruction for playing the note. The data may include lyrics associated with the musical piece. The methods may include the actions of generating the music file includes assigning timing information to lyrics. Generating the image may include generating a glyph for each note in the notation and storing information identifying the corresponding note in the notation in the image. Generating a musical file may include generating instructions for each note that cause the computer to play the corresponding note and storing information identifying the corresponding note in the notation in the musical file. Generating the mapping may include cross-referencing the information stored in the image and the information stored in the musical file.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 illustrates a user device presenting an integrated music file in a player.

FIG. 2 illustrates an example of an environment for providing sheet music to a user device.

FIG. 3 illustrates an example of a process for converting a music file into an integrated music file.

FIG. 4 illustrates an example of an application for presenting integrated music files.

FIG. 5 is a block diagram of a computer system and associated components.

Like reference symbols in the various drawings indicate like elements.

### DETAILED DESCRIPTION

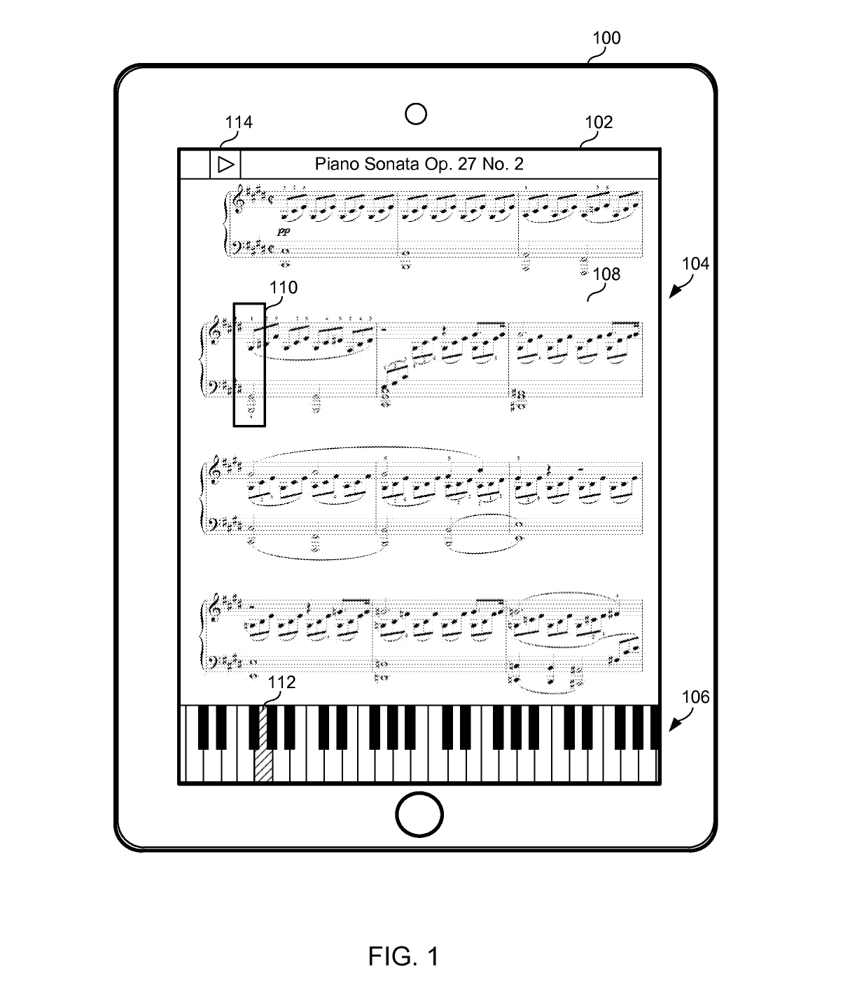

FIG. 1 illustrates a user device 100 presenting an integrated music file in a player. Integrated music files include, among other things, a sound file for playing the music through speakers on the user device 100 and an image of sheet music for displaying on the user device 100.

The user device 100 includes a display area 102. The user device 100 can be, for example, a mobile computer, a smart phone, a tablet device or other type of computing device. In this example, the player application executing on the user device 100 divides the display area 102 into two areas. A first area 104 displays the sheet music 108. A second area 106 displays a representation of a piano keyboard or other instrument (for example, a guitar, flute, clarinet, etc. . . . ).

The user device 100 also includes speakers capable of playing the sound file associated with the sheet music 108, for example, a musical instrument digital interface (MIDI) file. The user device presents a rectangle 110 or other type of graphical indicator in the first area 104. The rectangle 110 identifies the notes currently being played by the user device 100. At substantially the same time, the user device 100 highlights information in the second area 106 identifying how the notes being played by the user device 100 can be played on the instrument, for example, the piano keyboard. In some implementations, the information necessary to display the sheet music, play the music file, display the notes being played, and display an indicator of how to play the notes on a musical instrument are included in the integrated music file.

In the integrated music file the image of the sheet music is decoupled from the notes played through the MIDI file and the display of the notes being displayed in the second area 106 (for example, on the keyboard 106). The notes played and displayed are linked to the image of the sheet music through a mapping table. Therefore, elaborate pre-digital engravings can be included in the integrated music file.

In some implementations, the user device 100 displays a play/pause button 114 that controls playback of the sound file. In some implementations, as the sound file plays, the sheet music 108 is scrolled accordingly. Scrolling the sheet music (for example, by dragging a finger across the first area 104 or providing some other similar input) may rewind or advance the playback of the sound file.

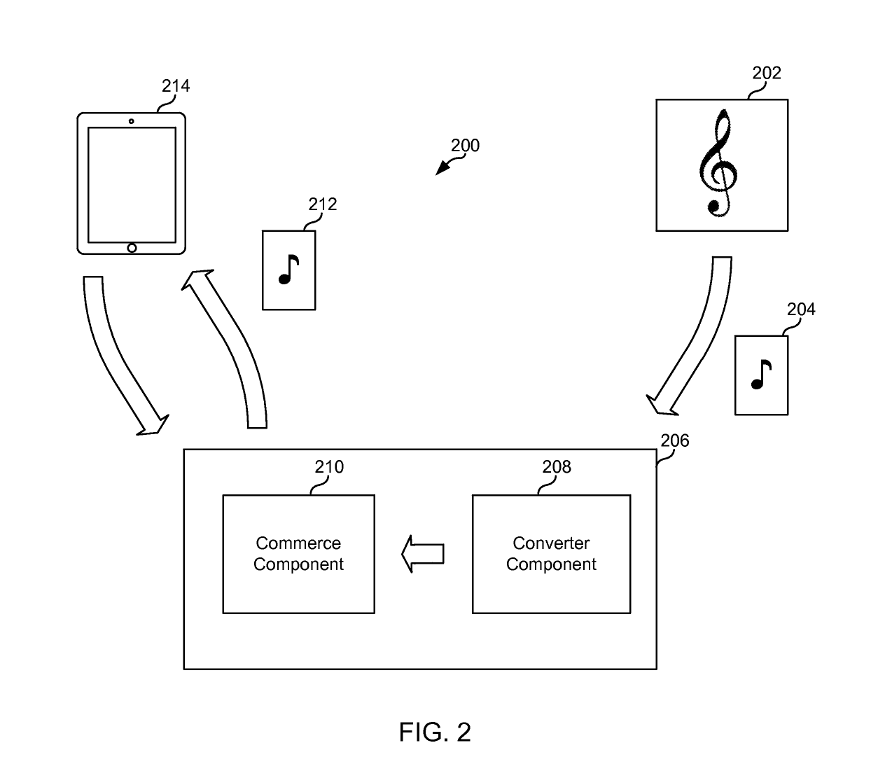

FIG. 2 illustrates an example environment for providing sheet music to a user device. A music publisher (represented with a G-clef icon 202) supplies a music file 204 to a computer system 206. Generally, the music file includes a representation of the music in a standard format. For example, the music publisher 202 may supply a Music extensible markup language (XML) file or one or more files that implement other file formats. The computer system can include one or more computing devices.

The computer system 206 receives the music file. A converter component 208 creates an integrated music file from the music file. The integrated music file may include an image of the sheet music, a sound file that enables a user device to play the music, instructions to play the music on an instrument including a graphical representation of a user's interaction with an instrument (e.g., graphically represented keystrokes that simulate a user touching individual keys of a keyboard), and a mapping file that enables a user device to synchronize the display of the sheet music and the instructions with the sound file. In some implementations, the converter component 208 is a process executing on one or more computing devices (e,g., the computer system 206). In some implementations, other data can be included in the integrated music file, for example, the integrated music file can contain an image of the composer, a history of the musical piece, cover art associated with the music file, a sound file of a musical recording of the piece (e.g. an mp3, aac, or similar recording) or other information. The integrated music file is sent to a commerce component 210 execute by the computer system 206. The commerce component presents the integrated music file for sale or licensing to a user of a user device 214 (e.g., a tablet computer). The user device 214 purchases the piece of music from the commerce component 210 and the commerce component 210 sends the integrated music file 212 to the user device 214.

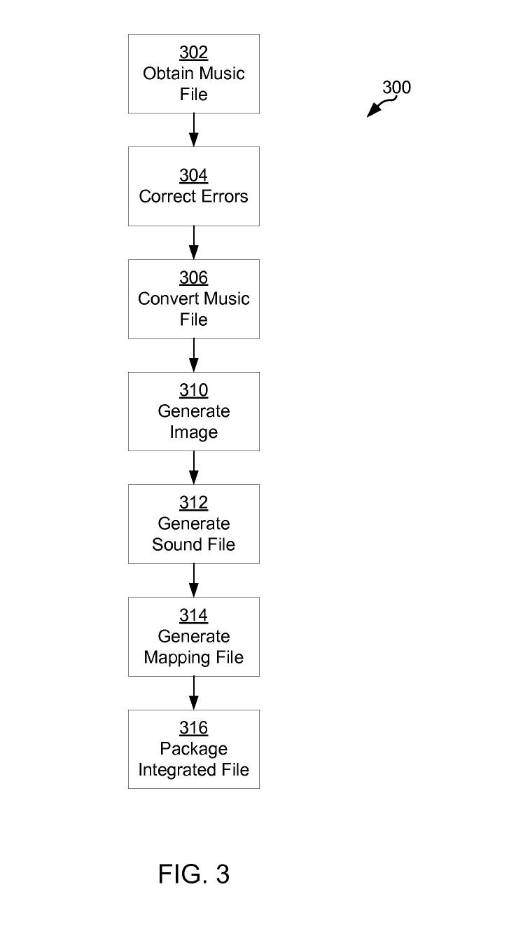

FIG. 3 illustrates an example of a process for converting a music file into an integrated music file. In this particular arrangement, the process 300 obtains 302 a music file, the music file contains a representation of sheet music. In some implementations, the music file is supplied in an industry standard format such as Music XML. Other formats, protocols, etc. may incorporated into the music file, for example, one or more proprietary formats may be utilized.

The process 300 corrects 304 errors in the music file. In some implementations, the process uses heuristics to identify the errors. For example, dynamics markings in sheet music (e.g. f, p, mp, cresc.) can be mistakenly represented as lyrics or just freeform text, and not as dynamics markings, thereby lose their meaning. An application attempting to play the music may ignore the dynamic marking because it is not properly labeled. Correcting errors can include examining non-dynamic text for items that appear to be dynamic signals that were misapplied. Similar heuristics are used to determine fingerings, lyrics, subtitles, directions, etc. that are not represented correctly in the music file.

Music files can include text that is provided to be visually accurate, but is provided in such a way that it is devoid of semantic meaning. That is, the text may indicate that a part of the text should be formatted appropriately but may not be designated explicitly. For example, the name of the composer or the subtitle to a piece of music may be formatted so that it appears in the proper place, but may not be designated as the composer or subtitle, respectively. In other scenarios, text may be stored as a musical directive when it is not.

The process can detect improperly designated text by examining the text itself. For example, subtitle may be stored as a directive associated with one or more notes in the music. A directive that begins with “from” is likely to be a subtitle and not a directive (e.g. “from The Magic Flute”). Dynamic markings can be identified by identifying well known dynamic marking symbols (e.g. “pp”, “p”, “mf”, etc. . . . ). Fingerings can be identified by looking for sequences of numbers in the text. In some scenarios, a music file may have a sequence of fingerings combined into a single field (e.g. “1 2), the process can identify the sequence as two fingerings “1” and “2” and correct accordingly.

The process can also identify tempo markings. Some music files include an explicit beat per minute (for example, as used by a metronome). Other music files contain text tempo instructions (e.g. “allegro”, “andante”, “vivace””. In some implementations, the process determines a beats per minute value corresponding to the text tempo instructions and adds the beats per minute value into the music file.

In some implementations, the process can utilize classifier and other machine learning techniques, such as support vector machines and data regression, to determine if a piece of text is appropriately designated.

The process 300 can convert 306 the music file into an intermediate format. In some implementations, the process converts the music file into an industry standard format.

The process can check for common errors in the music file and apply a correction in the intermediate format. For example, the process can determine that the number of beats in each measure matches the time signature (for example, that a piece of music in 4/4 time actually has 4 beats per measure).

The process can assign timing information to lyrics. In some implementations, the process assigning timings to each syllable. The process can also create an extender line under a series of notes that correspond to a single syllable in the lyrics. For example, for a syllable that is stretched out over several notes. In some implementations, the process compares the timing of the syllable to the timings for each note to determine if an extender line should be added.

Different music files can be provided in different formats. Some of the formats support programming constructs, such as looping blocks and macros. In some implementations, the process 300 may resolve looping constructs by expanding them. For example, a music file may include a looping such as:
repeat 2 {c d e f}

Indicating that the notes “c d e f” should be repeated twice. The process can resolve the loop to recite “c d e f c d e f” in the intermediate file.

In some implementations, the music file is tokenized and parsed into an abstract syntax tree that can be freely manipulated to remove looping blocks. The syntax tree can be used to recreate the music file. In some implementations, the loops are unrolled and the body of the loop is repeated as many times as necessary.

The process may resolve macros in a similar manner. In general, a macro is a short hand notation that may simplify the creation of a music file. For example, Beethoven's Moonlight Sonata has the same three notes repeated frequently. An individual creating a music file representation of the music may define a macro so that he need only type the name of the macro instead of the three notes. Any reference to a user-defined macro in the file may be removed and replaced with the body of the macro.

The process 300 generates 310 an image of the sheet music. In some implementations, glyphs are generated for each different musical annotation (e.g. quarter note, quarter rest, eighth note, etc. . . . ). Each glyph is associated with a position on the sheet music. The position of the glyph is stored along with information about the portion of the music file that caused the glyph to be generated. In some implementations, the information is stored in a scalable vector graphics (SVG) file. In some implementations, a more compact image file, for example, a joint photographic experts group (JPEG) file, portable document format (PDF) document, or portable network graphics (PNG) file is generated based on the SVG file.

The process 300 generates 312 a sound file. The sound file includes a representation for notes in the music file. In some implementations, the sound file includes information about the portion of the music file that caused the portion of the sound file to be generated. In some implementations, the sound file can be a musical instrument digital interface (MIDI) file. The information about the portion of the music file that caused the portion of the sound file to be generated can be stored in appropriate locations within the sound file (e.g, the “note on” and/or “note off” events of a MIDI message). In some implementations, the process 300 may obtain additional sound files from other sources, for example, a sound recording of a pianist playing the music.

The process 300 generates 314 a mapping file. The process creates a mapping identifying the portions of the image that correspond to the portions of the sound file. In some implementations, the mapping file is generated by comparing the portions of the music file that generated portions of the image file to the portions of the music file that generated portions of the sound file. Generating the mapping file may include correlating metadata in a MIDI file with metadata in an SVG file. The process finds common row and column offsets in the MIDI and SVG file and uses the common offsets to create the mapping file.

In some implementations, the mapping file includes a table that contains an ordered list of music systems, a list of staves, a list or barlines, and a list of mappings. The ordered list of music systems is a group of staves that get played together at the same time. For example, a line of music across all of the instruments in a piece. Each musical system can include a page number and a bounding box that identifies the location of the musical system on the image of the sheet music. The bounding box can be identified by an x and y coordinate, a width, and a height.

Each staff in the list of staves is associated with a musical system, as described above, in a location within the bounding box of the musical system. (for example, an x and y coordinate, and a height. In some implementations, the x and y coordinate can identify a location relative to the image of the sheet music. In other implementations, the x and y coordinate can identify a location relative to the bounding box of the musical system.

Each barline in the list of barlines is associated with a musical system, and an x coordinate. In some implementations, the x coordinate can identify a location relative to the image of the sheet music. In other implementations, the x can identify a location relative to the bounding box of the musical system.

Each mapping of the list of mappings can be associated with a musical system, an index of an associated MIDI event in the accompanying MIDI file, and an x coordinate. In some implementations, the x coordinate can identify a location relative to the image of the sheet music. In other implementations, the x can identify a T music file.

In some implementations, a mapping file may be generated for each sound file to be included in the integrated music file.

The process 300 packages 316 an integrated music file. In general, the process combines the sound file, the mapping file, and the image file to create the integrated music file. In some implementations, additional information can also be included in the integrated music file, for example, a thumbnail image associated with the sheet music.

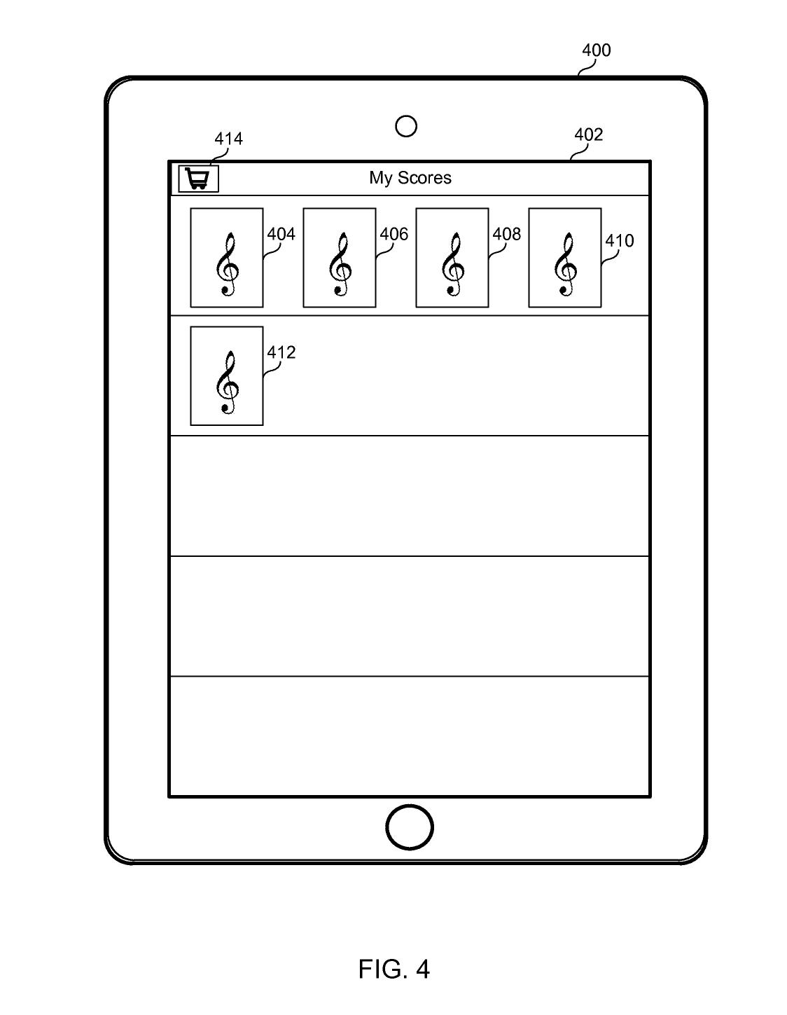

FIG. 4 illustrates an example of an application for presenting integrated music files. In this particular example, the application is executed by a user device 400 (e.g., a tablet computer) that includes a display area 402. The user device 400 can be, for example, the user device 100 of FIG. 1. The user device 400 displays a user interface for managing integrated music files. In one arrangement, the user device 400 displays cover art for the integrated music files that are on the user device 400. For example, the user device 400 displays cover art 404, 406, 408, 410, and 412. For demonstrative purposes, each cover art 404-412 is represented by a common symbol, however, typically each would be represented by unique artwork (e.g., the cover art of an album). A user of the user device 400 can tap on one of the cover art images. In response, the user device 400 opens a player, for example, the player described above with respect to FIG. 1.

The user device 400 also displays a shopping cart button 414. Selecting the shopping cart button brings the user into a music store where integrated music files may be purchased or licensed.

In some implementations, each integrated music file is displayed separately. In other implementations, integrated music files may be grouped together based on grouping criteria, for example, integrated music files may be grouped by composer. In some implementations, a user may organize and rearrange the cover art images by dragging and dropping them on the display area 402.

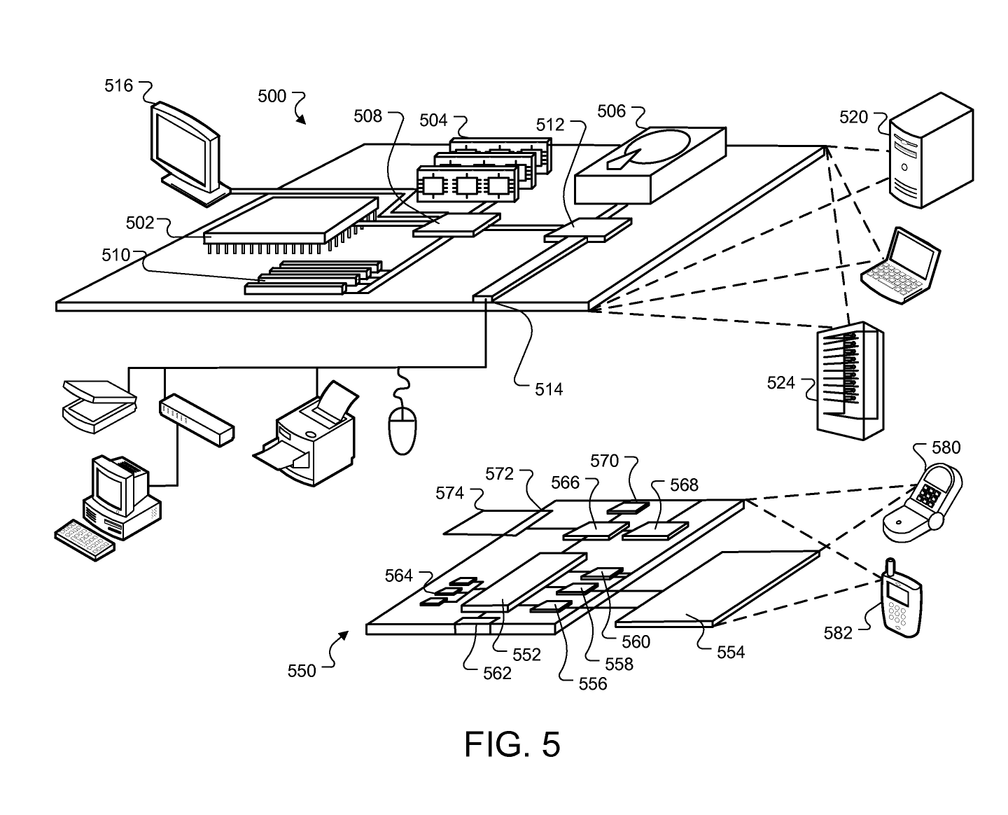

FIG. 5 shows an example of a computing device 500 and a mobile computing device 550 that can be used to implement the techniques described in this disclosure. For example, the computing device 500 could be computer system 206 shown in FIG. 2, and the mobile computing device 550 could be the user device 214 shown in FIG. 2.

The computing device 500 is intended to represent a device that processes and displays information. Some examples of such devices are various forms of digital computers, such as laptops, desktops, workstations, personal digital assistants, servers, blade servers, mainframes, and other appropriate computers. The mobile computing device 550 is intended to represent a wireless communication device. Some examples of such devices are various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 558, among other components. The mobile computing device 550 may also be provided with a storage device, such as a micro-drive or other device, to provide additional storage. Each of the processor 552, the memory 564, the display 554, the communication interface 566, and the transceiver 558, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 558 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 558 using a radio-frequency. In addition, short-range communication may occur, such as using a Bluetooth, WiFi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims. The techniques described herein can be performed in a different order and still achieve desirable results.

What is claimed is:

1. A computer-implemented method comprising:
receiving data representative of notation associated with a musical piece, the notation including notes;
generating an image that includes at least one glyph, the glyph including a graphical representation of a note in the notation of the musical piece;
generating a musical file, the music file including instructions for causing the computer to play the notes;
generating a mapping that referencing the instructions and the glyph; and
generating a sheet music data file, the sheet music data file including the image, the music file, and the mapping.

2. The method of claim 1, further comprising:
receiving second data representative of text associated with the music piece;
identifying dynamic markings in the text; and
updating the notation with the dynamic markings.

3. The method of claim 1, wherein generating the mapping comprises:
identifying a location of a glyph of the at least one glyph relative to the image, the glyph corresponding to a note; and
storing the in the music file instruction for playing the note.

4. The method of claim 1, wherein the data further includes lyrics associated with the musical piece; and
generating the music file includes assigning timing information to lyrics.

5. The method of claim 1, wherein generating the image comprises:
generating a glyph for each note in the notation; and
storing information identifying the corresponding note in the notation in the image.

6. The method of claim 5, wherein generating a musical file comprises:
generating instructions for each note that cause the computer to play the corresponding note; and
storing information identifying the corresponding note in the notation in the musical file.

7. The method of claim 6, wherein generating the mapping comprises cross-referencing the information stored in the image and the information stored in the musical file.

8. A computer storage device encoded with computer program instructions that when executed by one or more computers cause the one or more computers to perform operations comprising:
receiving data representative of notation associated with a musical piece, the notation including notes;
generating an image that includes at least one glyph, the glyph including a graphical representation of a note in the notation of the musical piece;
generating a musical file, the music file including instructions for causing the computer to play the notes;
generating a mapping that referencing the instructions and the glyph; and
generating a sheet music data file, the sheet music data file including the image, the music file, and the mapping.

9. The device of claim 7, wherein the instructions that when executed by one or more computers further cause the one or more computers to perform operations comprising:
receiving second data representative of text associated with the music piece;
identifying dynamic markings in the text; and
updating the notation with the dynamic markings.

10. The device of claim 7, wherein generating the mapping comprises:
identifying a location of a glyph of the at least one glyph relative to the image, the glyph corresponding to a note; and
storing the in the music file instruction for playing the note.

11. The device of claim 7, wherein the data further includes lyrics associated with the musical piece; and
generating the music file includes assigning timing information to lyrics.

12. The device of claim 7, wherein generating the image comprises:
generating a glyph for each note in the notation; and
storing information identifying the corresponding note in the notation in the image.

13. The device of claim 12, wherein generating a musical file comprises:
generating instructions for each note that cause the computer to play the corresponding note; and
storing information identifying the corresponding note in the notation in the musical file.

14. The method of claim 13, wherein generating the mapping comprises cross-referencing the information stored in the image and the information stored in the musical file.

15. A system comprising:
one or more computers and one or more storage devices storing instructions that are operable, when executed by the one or more computers, to cause the one or more computers to perform operations comprising:
receiving data representative of notation associated with a musical piece, the notation including notes;
generating an image that includes at least one glyph, the glyph including a graphical representation of a note in the notation of the musical piece;
generating a musical file, the music file including instructions for causing the computer to play the notes;
generating a mapping that referencing the instructions and the glyph; and
generating a sheet music data file, the sheet music data file including the image, the music file, and the mapping.

16. The system of claim 15, wherein the instructions that when executed by one or more computers further cause the one or more computers to perform operations comprising:
receiving second data representative of text associated with the music piece;
identifying dynamic markings in the text; and
updating the notation with the dynamic markings.

17. The system of claim 15, wherein generating the mapping comprises:
identifying a location of a glyph of the at least one glyph relative to the image, the glyph corresponding to a note; and
storing the in the music file instruction for playing the note.

18. The system of claim 15, wherein the data further includes lyrics associated with the musical piece; and
generating the music file includes assigning timing information to lyrics.

19. The system of claim 15, wherein generating the image comprises:
generating a glyph for each note in the notation; and
storing information identifying the corresponding note in the notation in the image.

20. The system of claim 19, wherein generating a musical file comprises:
generating instructions for each note that cause the computer to play the corresponding note; and
storing information identifying the corresponding note in the notation in the musical file.

21. The system of claim 20, wherein generating the mapping comprises cross-referencing the information stored in the image and the information stored in the musical file.
